(19) United States
(12) Patent Application Publication
(10) Pub. No.: US 2009/0049487 A1
(43) Pub. Date: Feb. 19, 2009

(54) ROUTER APPARATUS AND NETWORK TROUBLE DETERMINING METHOD

(75) Inventors: Teruo Koukai, Nara (JP); Yasuhiro Iwai, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/067,519

(22) PCT Filed: Dec. 6, 2006
(86) PCT No.: PCT/JP2006/324341

§ 371 Date: Mar. 20, 2008

(30) Foreign Application Priority Data
Dec. 8, 2005 (JP) 2005-354403

(51) Int. Cl. H04N 7/173; G06F 15/16; G06F 11/07

(52) U.S. Cl. 725/87; 709/238; 714/57; 714/E11.025

(57) ABSTRACT

The router apparatus monitors packets among plural networks and relays the packets among the networks based on information obtained from the packets. The router apparatus includes an HTTP server and a speed measuring page. The HTTP server monitors a transmission request from an HTTP client and transmits information to the client on the basis the request. The speed measuring page includes information on which the transmission speed of data is measured in a storage device controlled by the HTTP server. A terminal requests transmitting the speed measuring page and measures a bit rate between the router apparatus and the terminal according to information in the speed measuring page transmitted responding to the request.

This application is a U.S. National Phase Application of PCT International Application PCT/JP2006/324341.

### TECHNICAL FIELD

The present invention relates to an IP communication network, particularly to an apparatus and method for identifying a location where a communication trouble has occurred in the network.

### BACKGROUND ART

In digital television, streaming has become easy to be implemented as a result that the standards for terrestrial digital broadcasting require a digital television set to be equipped with an interface for IP communications. That is, video-on-demand services and IP broadcasting have become easy to be implemented.

In ordinary households, plural terminal devices such as computers tend to be connected to a network mainly for using the Internet. According to such changes in the environment, a digital television set equipped with an IP communication interface as standard tends to be connected to this network as a member thereof.

Conventionally, only an expert is able to construct a network such as a LAN; currently, a user with poor expertise can do it as long as he or she follows an instruction manual. However, once a problem such as a fault in a network occurs, it is difficult not only to handle it but to identify its location. If at least its location and cause are presumed, some handling can be made by inquiring at such as a service center.

A description is made for a conventional technique allowing a user with poor expertise to distinguish the location and cause of a trouble in a network, using FIGS. 6, 7.

FIG. 6 is a block diagram illustrating the configuration of a network according to a conventional technique. Communication apparatus 700 is a television set having a communication means. Communication apparatus 700 has controller 720 checking communication conditions; and Ethernet (registered trademark) controller 750 performing a process of physically connecting to the Internet. Input unit 740 starts up communication apparatus 700 through controller 720. Input unit 740 further has memory unit 730 storing the factory-determined IP address of a test server.

The operation of communication apparatus 700 thus configured is described.

FIG. 7 is a flowchart illustrating the procedure of determining network troubles, according to a conventional technique. In FIG. 7, if connection fails although the user connects wires as shown in FIG. 6, the user first sends a communication check command to controller 720 through input unit 740. Responding to the command, controller 720 directs Ethernet controller 750 to connect to hub 820. The Ethernet controller then tries to communicate with hub 820. If communications with hub 820 fail, apparatus 700 regards a problem is present before hub 820, displays accordingly, and ends checking.

If communications with hub 820 succeed, apparatus 700 tries to communicate with home router apparatus 830. If communications with home router apparatus 830 fail, apparatus 700 regards a problem is present between hub 820 and home router apparatus 830, displays accordingly, and ends checking.

In other words, apparatus 700 tries communications with devices in the order of closeness to the terminal, and judges the location of a problem where communications fail. Having communication apparatus 700 include a program for executing such a procedure allows a user with poor expertise to easily identify the location of a failure in the network. Here, whether communication is possible or not is judged by presence or absence of a reply to a ping command issued to a given device (refer to patent literature 1, for example).

In recent years, services have been rapidly expanding based on high-speed Internet access (e.g. FTTH) such as video distribution by video on demand and other methods. However, video distribution services such as video on demand are implemented through an IP network featuring best-effort connection, and thus a bit rate for transmitting a video normally is not assured.

If the band of an out-of-home network is around 100 Mbps for example, if the user replay a distributed video by the video distribution services form the network, while the user is running an application (download of a file, streaming etc.) that utilizes a 95-Mbps band, and if the bit rate of content to be viewed is 20 Mbps, the sound is interrupted and the video is disturbed. Meanwhile, if the bit rate as the whole network is reduced as a result that a 10-Mbps device is used as a home network node due to poor expertise, and if the bit rate of content is 20 Mbps, the sound is interrupted and the video is disturbed even if other processes are not running.

According to a conventional technique, distinguishing problems is limited to checking accessibility by a ping command. Therefore, even if a problem is identified in communications that do not matter communication speed, the user cannot identify the cause of a problem that matters communication speed because its band is uncertain. Consequently, the user eventually contacts the television set manufacturer or the customer service center of the communications carrier, but the problem is not solved due to uncertain circumstances.
[Patent literature 1] Japanese Patent Unexamined Publication No. 2004-364278

### SUMMARY OF THE INVENTION

A router apparatus of the present invention is one that monitors packets among plural networks and that relays packets based on information obtained from the packets. The router apparatus includes an HTTP server that monitors a transmission request from an HTTP client and that transmits information to the client based on the transmission request; and a storage device controlled by the HTTP server, where the storage device has a transmission speed measuring page including information for measuring the transmission speed of data. Here, HTTP (Hyper Text Transfer Protocol) refers to a protocol that a server and client use to send and receive data.

In a network including the above-described router apparatus and a terminal connected to the router apparatus and having a browser for requesting the router apparatus to transmit information for controlling, the network trouble determining method of the present invention has a requesting step of requesting to transmit a speed measuring page by the terminal; and a measuring step of measuring the bit rate between the router apparatus and the terminal according to information in the speed measuring page transmitted responding to the request.

With such a configuration, after the terminal requests the speed measuring page from the router apparatus, measuring the bit rate between the router apparatus and terminal enables judging presence or absence of a trouble between the router apparatus and the terminal. Consequently, problems can be easily distinguished even if a trouble in the network is related to communication speed.

### BRIEF DESCRIPTION OF DRAWINGS

FIG. 1 illustrates a configuration of a network according to the first exemplary embodiment of the present invention.

FIG. 2 illustrates a conceptual configuration of the information flow according to the first embodiment of the present invention.

FIG. 3 illustrates a detailed hardware configuration of the browser according to the first embodiment of the present invention.

FIG. 4A is a list screen of video-on-demand content displayed by the browser according to the first embodiment of the present invention.

FIG. 4B is a detailed screen of content displayed by the browser according to the first embodiment of the present invention.

FIG. 5 is a flowchart illustrating the procedure for measuring on a speed measuring page according to the first embodiment of the present invention.

FIG. 6 is a block diagram illustrating a configuration of a network according to a conventional technique.

FIG. 7 is a flowchart illustrating the procedure for determining network troubles, according to the conventional technique.

### REFERENCE MARKS IN THE DRAWINGS

101 Router apparatus
102 Digital television set
103 Video distribution server
104 Network device
105 Home network
106 Out-of-home network
201 Input unit
202 Display unit
203 Browser
204 HTTP server
205 Storage device
206 Setting page
207 Speed measuring page
208 External HTTP server
209 External speed measuring page
210 External storage device
301 IR light receiver
302 CPU
303 RAM
304 ROM
305 Graphics controller
306 Ethernet controller
401 Video content
402 Replay button

### DETAILED DESCRIPTION OF PREFERRED EMBODIMENTS

### First Exemplary Embodiment

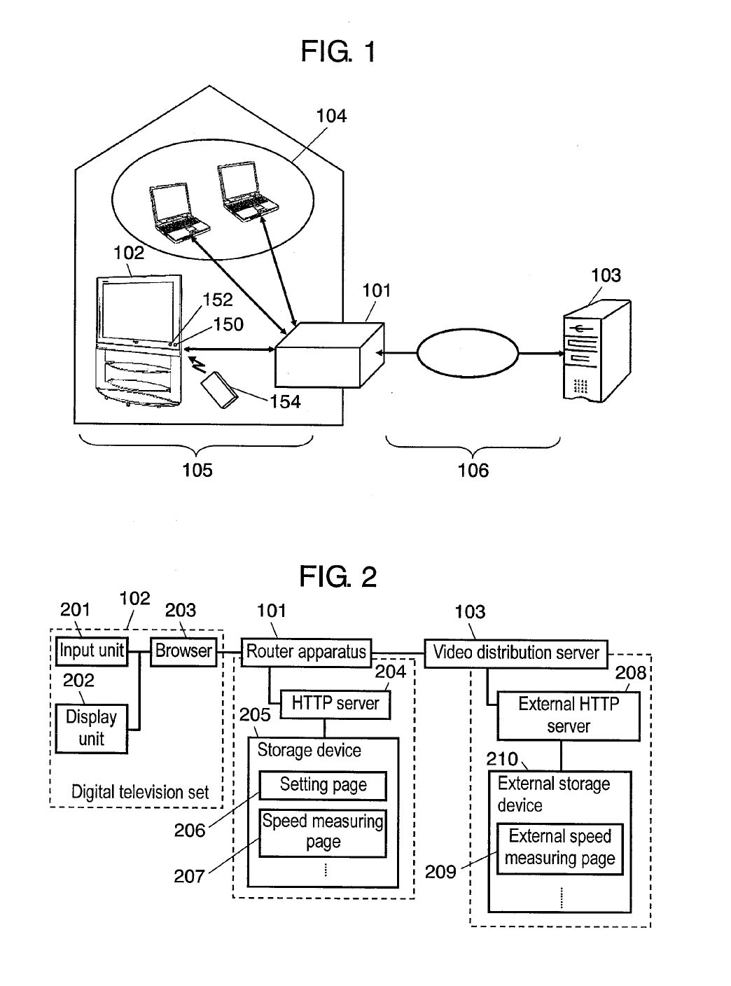

FIG. 1 illustrates a configuration of a network according to the first exemplary embodiment of the present invention. In FIG. 1, digital television set 102 as a terminal receives common broadcast waves to present program content and includes a browser for acquiring content through the network. For example, set 102 acquires video streams through Ethernet to provide users with audio and video by the same process as for streams transmitted via digital broadcast waves.

Router apparatus 101 separates home network 105 from out-of-home network 106 maintained by its communications carrier. Apparatus 101 usually monitors packets among plural networks and relays packets based on information obtained from the packets. Apparatus 101 of the present invention further has HTTP server 204 (to be described in detail later).

FTTH requires a usual terminator for converting a fiber-optic cable to a metal wire with approximately 100 Mbps to draw wires into home from out-of-home network 106. ADSL as well requires a splitter for splitting from a metal wire. In the first embodiment of the present invention, such a terminator and the like are assumed to be included in the functions of router apparatus 101 of the present invention. That is to say, router apparatus 101 relaying data among at least two networks applies to the present invention. An apparatus generally called a router, or an apparatus for separating a home network from the out-of-home network, integrally composed of plural devices, is assumed to apply to router apparatus 101 of the present invention. Further, even an intelligent hub equipped with an HTTP server, which monitors packets among plural networks and relays data among at least two networks (including a case of a single terminal), also applies to the present invention.

Next, this router apparatus 101 has various types of network devices 104 connected thereto, such as digital television set 102, and a notebook PC and a desktop PC present at home, composing home network 105 as a whole.

Video distribution server 103 is connected as a given site in out-of-home network 106 such as an IPv6 network. Server 103 transmits streams of video content accumulated in the hard disk toward home network 105 (to a terminal) by a protocol for streaming from the terminal.

Next, a description is made for the details of each component according to the first embodiment of the present invention, using FIG. 2. FIG. 2 illustrates a conceptual configuration of the information flow according to the first embodiment of the present invention, where FIG. 2 does not necessarily show hardware configuration of the physical layer. A component same as that in FIG. 1 is given the same mark, and a component irrelevant to operation characteristic of the present invention is omitted.

In FIG. 2, besides components for usual television functions, digital television set 102 includes input unit 201, browser 203, and display unit 202. Input unit 201 functions as a user interface including up/down/right/left keys of remote controller 154 for browser 203, and Input Method Editor for entering URLs into browser 203. Responding to directions from input unit 201, browser 203 requests and acquires content from an external server, and then shows the user the result on display unit 202.

Browser 203 of the present invention refers to the generic name for a functional block that requests and acquires information through a network; and to the user, that presents content and displays such as an operation screen to receive instructions.

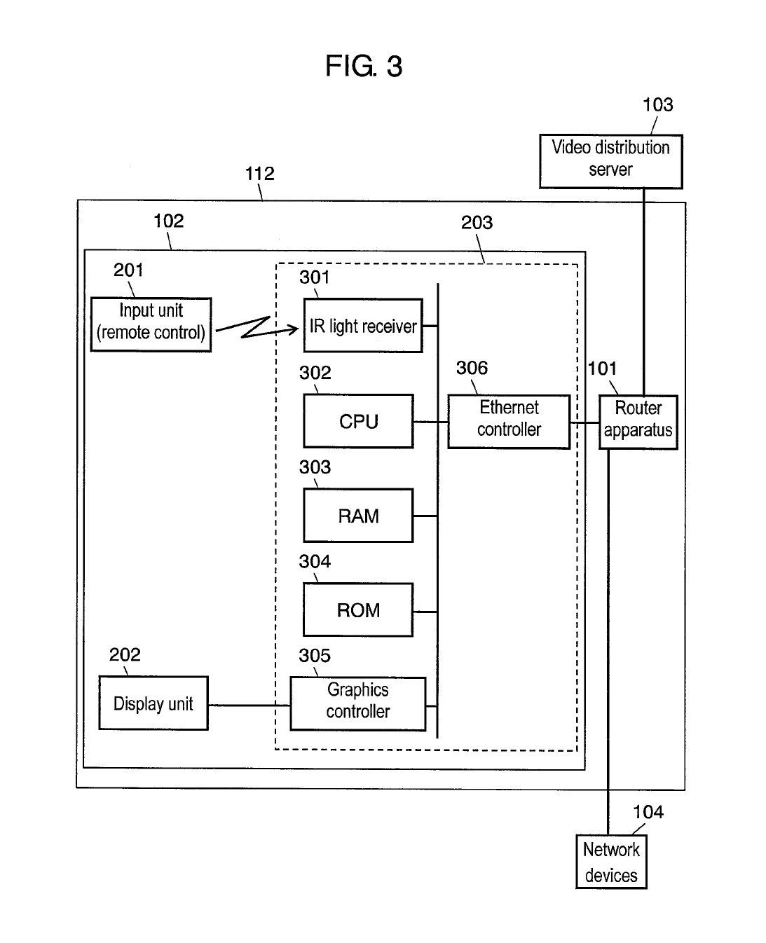

FIG. 3 illustrates a detailed hardware configuration of the browser 203 according to the first embodiment of the present invention. In FIG. 3, browser 203 includes Ethernet controller 306, IR light receiver 301, graphics controller 305, CPU 302, RAM 303, and ROM 304, from the viewpoint of hardware. Ethernet controller 306 is connected to a network device such as a router apparatus. IR light receiver 301 receives infrared signals from remote controller 154 and converts them to pulse signals representing a command. Graphics controller 305 displays information acquired and a screen for accepting operation instructions from the user. CPU 302 controls these devices on its bus by given programs. RAM 303 and ROM 304 are storage devices for storing programs for operating CPU 302 and various data. From the viewpoint of software, browser 203 has a function for acquiring through a communication network, markup documents described in such as HTML or BML and objects referred from the documents. Browser 203 further operates by software for analyzing a syntax, layouting, executing a script, and displaying these results in graphics. The browser of the present invention is composed of the hardware, and the software and data for controlling the hardware as a whole to operate.

From the viewpoint of the information flow, browser 203 is supposed to connect directly to router apparatus 101. FIG. 2 thus shows as browser 203 connects directly to router apparatus 101, omitting detailed components in FIG. 3 to make the invention easily understood.

Router apparatus 101 of the present invention separates the user's home network 105 from the communications carrier's. Router apparatus 101 has HTTP server 204 for outwardly supplying a setting page for setting therewith parameters and others for router functions. This HTTP server 204 monitors a transmission request from a HTTP client and transmits information (file) to the client according to the request. HTTP server 204 accumulates in storage device 205, screens to be presented to the user, described in a given format.

Setting page 206 is a piece of information accumulated in storage device 205. Router apparatus 101 of the present invention has speed measuring page 207 linking to setting page 206 provided. This speed measuring page 207 is described a measuring procedure of the transmission speed of data between HTTP server 204 in router apparatus 101 and browser 203 in digital television set 102. Page 207 executes a Java (registered trademark) script in the description described in html, for example, to read given data controlled by HTTP server 204. Browser 203 then calculates a bit rate from the amount of data having been read and the time required to read the data, and presents the bit rate. Thus, digital television set 102 measures the transmission speed between digital television set 102 and router apparatus 101.

Meanwhile, video distribution server 103 includes external HTTP server 208 and external storage device 210. Device 210 has external speed measuring page 209.

In the network configured as described above, a description is made for the usual operation where the user enjoys video distribution services through video on demand.

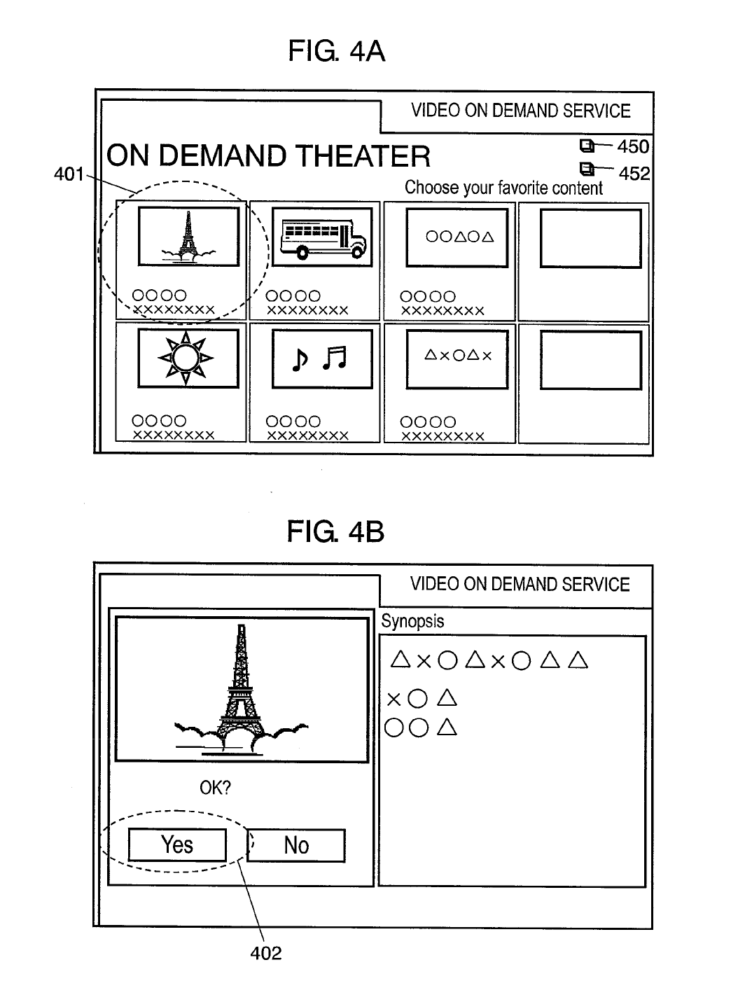

FIGS. 4A, 4B show an example of an operation screen displayed by browser 203 contained in digital television set 102 as software. More specifically, FIG. 4A is a list screen of video-on-demand (VOD) content displayed by browser 203 according to the first embodiment of the present invention. FIG. 4B is a detailed screen of content displayed by browser 203 according to the first embodiment of the present invention.

The user enters the URL of video distribution server 103 into browser 203 screen displayed on digital television set 102. Then, a list screen of VOD content, as shown in FIG. 4A, is transmitted from video distribution server 103 and displayed on the screen of digital television set 102. The user chooses content by operations of remote controller 154 to switch to the detailed screen of content in FIG. 4B. If video content 401 shown in FIG. 4A is chosen, for example, the detailed screen of content with the details of video content 401 described therein is displayed. Next, replay button 402 on the content in the detailed screen of content in FIG. 4B is pressed, digital television set 102 outputs a video distribution request signal to video distribution server 103 through home network 105. When video distribution server 103 receives the signal, server 103 outputs streams of the video content to home network 105. When digital television set 102 receives the streams, set 102 decodes them to output audio and video.

By the above process, the user can receive video-on-demand services.

However, when some trouble occurs and video by the video distribution service is disturbed, the following measures are taken.

When video is disturbed, the user enters the URL of router apparatus 101 from input unit 201. Responding to this entry, browser 203 requests the URL from router apparatus 101. Router apparatus 101 having received the request transfers the request to HTTP server 204, which then returns the index page of the URL as a reply to the request. Here, if this index page is assigned to the above-described setting page 206, the data on setting page 206 is transmitted to browser 203. Browser 203 displays setting page 206 having been acquired on display unit 202 to provide the user with the information.

For router apparatus 101 having a protocol called UPnP (Universal Plug and Play), the user does not need to enter the URL directly. In this case, browser 203 supports UPnP, and a node supporting UPnP (in the first embodiment of the present invention, router apparatus 101 is such a node) is indicated by an icon. Choosing the icon with the up/down/right/left keys of remote controller 154 allows the page designated by the URL to be entered to browser 203.

Next, when speed measuring page 207 linking to setting page 206 is chosen, a request for the corresponding URL is made from browser 203 to router apparatus 101 as well. Then, router apparatus 101 returns speed measuring page 207 to browser 203 as a reply to the request.

In the above-described operation, the method is described in which links are followed from setting page 206 to acquire speed measuring page 207. However, page 207 may be acquired by directly requesting the URL designating speed measuring page 207 without using setting page 206. Alternatively, when the user chooses speed measurement button 450 prepared on the command acceptance screen of browser 203, the URL of speed measuring page 207 stored in browser 203 may be transmitted. Digital television set 102 may also have speed measurement bottom 150 on the front panel, as is shown in FIG. 1. Thus, the network trouble determining method according to the present embodiment has a requesting step of requesting router apparatus 101 to transmit a speed measuring page 207 by digital television set 102 as a terminal.

Browser 203 thus displays speed measuring page 207 on the screen of display unit 202. Browser 203 executes a measuring step which measures the transmission speed according to the description on speed measuring page 207.

Next, a description is made for operation of speed measurement according to the description on speed measuring page 207.

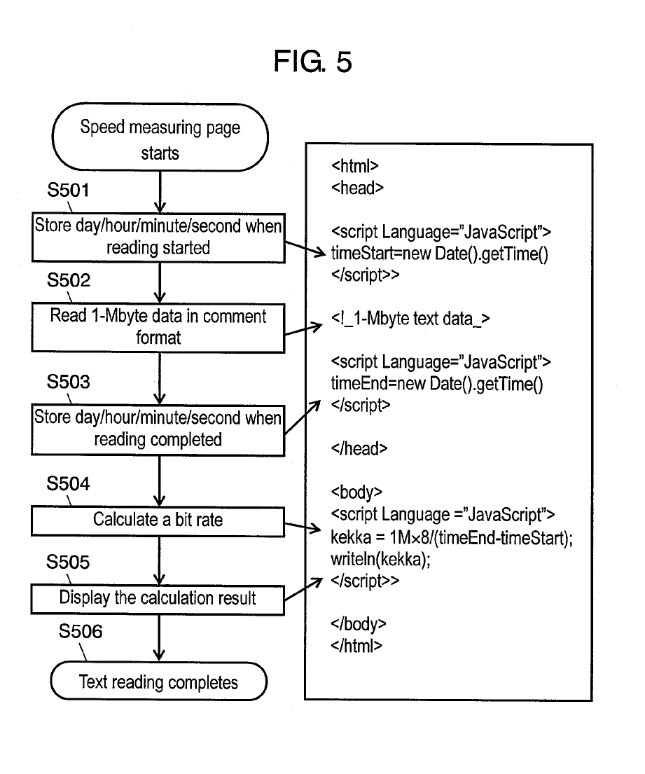

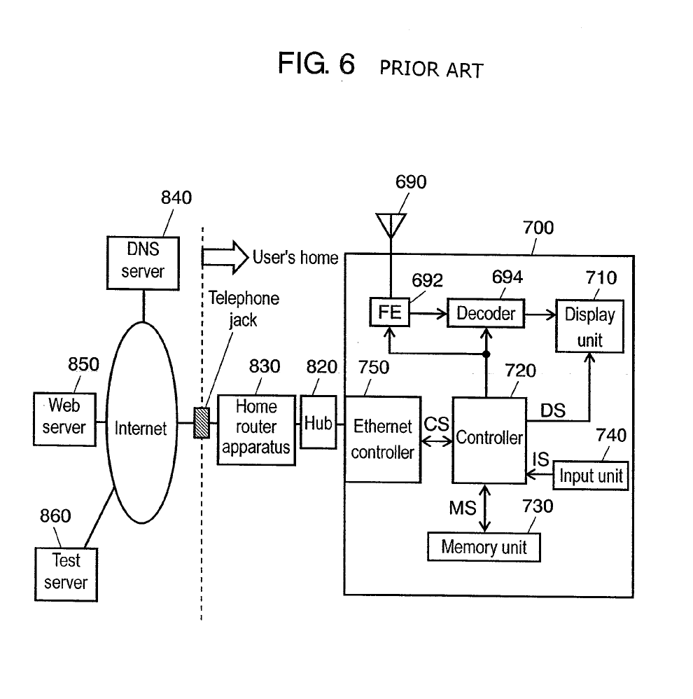

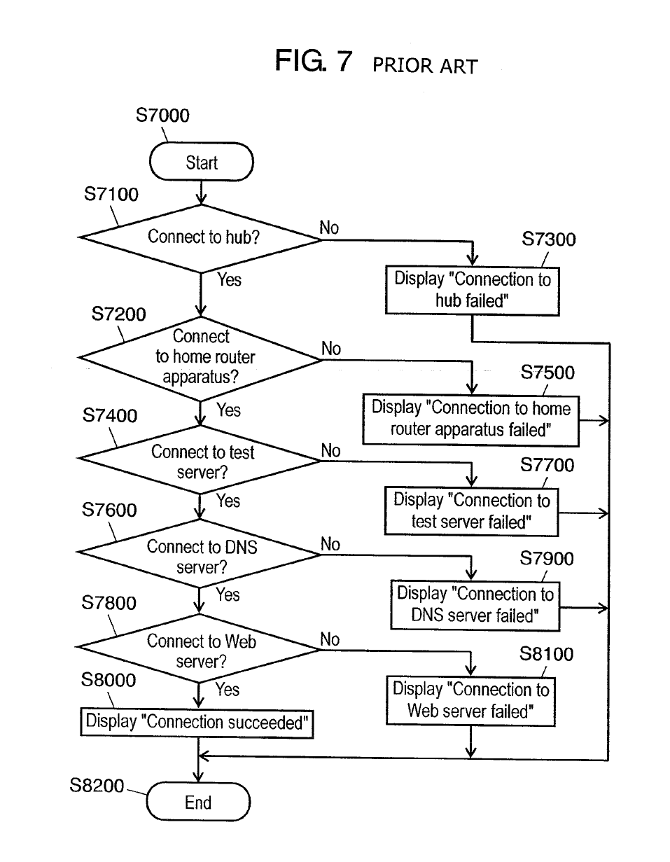

FIG. 5 is a flowchart illustrating the procedure for measuring on the speed measuring page according to the first embodiment of the present invention. An example excerpt from the speed measuring page described in html is shown, and the correspondences are indicated by arrows.

In FIG. 5, when speed measuring page 207 is read into browser 203, the time point when the reading started is stored by browser 203 according to the description (S501). Browser 203 further reads given bytes of data (described as a comment) to continue acquiring the page being read. In the first embodiment of the present invention, 1-Mbyte data (an example) is read (S502). As the reading proceeds, the current time point is acquired to be stored as a time point when the reading completed (S503). Next, in a measuring step a bit rate is calculated by determining the ratio of the number of bytes of data to be read, having been set, to the time distance between the time point when the reading completed and that started (S504). Then, browser 203 displays the calculation result (S505). As described above, the measuring step is completed by measuring a bit rate between router apparatus 101 and digital television set 102 according to information in the speed measuring page 207 transmitted from router apparatus 101 responding to the request from digital television set 102 as the terminal. Display unit 202 displays the calculation result to complete reading of the document (S506).

As described hereinbefore, the bit rate according to speed measuring page 207 represents available bands of the network between digital television set 102 and router apparatus 101. This display result allows the user to learn circumstances of home network 105.

In the first embodiment of the present invention, display unit 202 displays the calculation result of the bit rate. However, display unit 202 may display a presence or an absence of a trouble in home network 105 based on the calculation result of the bit rate. As described above, a display step of displaying whether or not a trouble is present in home network 105 based on the result obtained in the measuring step may further be included. In this case, a user with poor expertise can judge presence or absence of a trouble more easily.

The measurement result of the bit rate obtained from the above-described measurement represents a state of only home network 105, completely independently of out-of-home network 106. Accordingly, if speed measuring page 207 displays incorrectly, or if the speed is lower than the bit rate of video content to be distributed, the judgment can be made that home network 105 is in trouble. Otherwise, if the bit rate measured is normal although a trouble such as disturbed video is occurring, the judgment can be made that at least home network 105 is normal and the other is in trouble.

Further, for video distribution server 103, obtaining the bit rate between video distribution server 103 and browser 203 using external speed measuring page 209 allows the user to learn circumstances of the out-of-home network 106.

More specifically, when the user chooses external speed measurement button 452 prepared on the command acceptance screen of browser 203, the URL of external speed measuring page 209 stored in browser 203 may be transmitted. Digital television set 102 may also have external speed measurement bottom 152 on the front panel, as is shown in FIG. 1. Then, browser 203 included in digital television set 102 as the terminal first executes an external requesting step of requesting video distribution server 103 via router apparatus 101 to transmit external speed measuring page 209. Video distribution server 103 then transmits information in external speed measuring page 209 to digital television set 102 according to the transmission request received. Then, as shown in FIG. 5, external speed measuring image 209 of external HTTP server 208 included in video distribution server 103 is read into browser 203 of digital television set 102 as the terminal. Next, digital television set 102 executes an external measuring step of measuring a bit rate between the terminal and video distribution server 102 according to the description as described below.

First, the time point when the reading started is stored by browser 203 (S501). Browser 203 further reads given bytes of data (described as a comment) to continue acquiring the page being read. In the first embodiment of the present invention, 1-Mbyte data (an example) is read (S502). As the reading proceeds, the current time point is acquired to be stored as a time point when the reading completed (S503). Next, in a measuring step, a bit rate is calculated by determining the ratio of the number of bytes of data to be read, having been set, to the time distance between the time point when the reading completed and that started (S504). Then, browser 203 displays the calculation result (S205). Display unit 202 displays the calculation result to complete reading of the document (S506). As a result, digital television set 102 is capable of measuring transmission speed of data between digital television set 102 and video distribution server 103.

As described hereinbefore, the bit rate according to external speed measuring page 209 represents available bands of the network between digital television set 102 and video distribution server 103. This display result allows the user to learn circumstances of home network 105.

In the first embodiment of the present invention, display unit 202 displays the calculation result of the bit rate. However, display unit 202 may display a presence or an absence of a trouble in out-of-home 106 network based on the calculation result of the bit rate. As described, a display step of displaying whether or not a trouble is present in out-of-home network 106 based on the result obtained in the measuring step may further be included. In this case, a use with poor expertise can judge presence or absence of a trouble more easily.

If there is a problem with the bit rate between the terminal and video distribution server 103 although the measurement result of the bit rate between the terminal and router apparatus 101 is normal, the judgment can be made that a trouble is occurring on a network between video distribution server 103 and router apparatus 101. If both bit rates are normal although a trouble such as disturbed video is occurring, the judgment can be made that the network related to communications is normal and there is a problem with content data itself.

In the first embodiment of the present invention, as shown in FIG. 3, both digital television set 102 and router apparatus 101 are included in home network 105 and connected each other within home network 105. However, as shown in FIG. 3, digital television set 102 may include router apparatus 101. Even with such a configuration, for video distribution server 103, digital television set 102 allows the user to learn circumstances of out-of-home network 106 by obtaining the bit rate between video distribution server 103 and browser 203 using external speed measuring page 209.

In the first embodiment of the present invention, speed measurement bottom 150 and external speed measurement bottom 152 are disposed on the front panel of digital television set 120, however speed measurement bottom 150 and external speed measurement bottom 152 can be disposed on, for example, a portion of the top wall or the side walls of digital television set 120. The positions should be easily touchable by a user. Furthermore, as shown in FIG. 1, remote controller 154 of digital television set 102 can dispose speed measurement bottom 150 and external speed measurement bottom 152. In this case, a user poor expertise can judge presence or absence of a trouble more easily.

In the first embodiment of the present invention, display unit 202 displays the calculation result of the bit rate. However, display unit 202 may display a presence or an absence of a trouble in the home network and that in the out-of-home network based on the calculation result of the bit rate. In this case, a user with poor expertise can judge presence or absence of a trouble more easily.

The above-described configuration and operation allow the user to distinguish whether the home or out-of-home network environment is defective, or the communications carrier is responsible.

In the first embodiment of the present invention, the description is made for the procedure for handling a network trouble when it is occurring. However, for a network including a router apparatus of the present invention, the judgment can be made whether the bit rate determined when the network was constructed enables the network to work, thereby preventing a network trouble.

### INDUSTRIAL APPLICABILITY

A router apparatus and network trouble determining method according to the present invention enable distinguishing problems easily if a trouble occurs in a network and even if the trouble is related to communication speed, which means the invention is useful in an IP communication network and others.

1. A router apparatus comprising:
an HTTP server that monitors a packet among a plurality of networks, relays the packet based on information obtained from the packet, separates a home network from an out-of-home network, monitors a transmission request from an HTTP client provided in a terminal included in the home network and transmits information to the HTTP client based on the transmission request; and
a storage device that is controlled by the HTTP server and has a speed measuring page including information for measuring data transmission speed.

2. A network trouble determining method comprising:
a requesting step of requesting the router apparatus to transmit the speed measuring page by the terminal; and
a measuring step of measuring a bit rate between the router apparatus and a terminal according to information in the speed measuring page transmitted from the router apparatus responding to the request by the terminal,
wherein the router apparatus includes:
an HTTP server that monitors a packet among a plurality of networks, relays the packet based on information obtained from the packet, separates a home network from an out-of-home network, monitors a transmission request from an HTTP client and transmits information to the HTTP client based on the transmission request; and
a storage device that is controlled by the HTTP server and has the speed measuring page including information for measuring data transmission speed,
wherein the terminal is connected to the router apparatus through the home network.

3. The network trouble determining method of claim 2, wherein the measuring step includes calculating a ratio of the number of bytes of set data to be read, to a time obtained by a difference time between completion of reading and starting of reading.

4. The network trouble determining method of claim 2, further comprising:
a display step of displaying whether or not a trouble is present in a home network based on a result obtained in the measuring step.

5. The network trouble determining method of claim 2, further comprising:
an external requesting step of requesting a video distribution server to transmit an external speed measuring page by the terminal; and
an external measuring step of measuring a bit rate between the terminal and the video distribution server according to information in the external speed measuring page transmitted from the video distribution server to the terminal via the router apparatus responding to the transmission request by the terminal,
wherein the out-of-home network connected to the home network includes the video distribution server,
wherein the video distribution server includes:
an external HTTP server; and
an external storage device,
wherein the external HTTP server accumulates a screen to be presented to a user described in a given format in the external storage device,
wherein the external storage device includes an external speed measuring page including information for measuring data transmission speed between the terminal and the video distribution server.

6. The network trouble determining method of claim 5, further comprising:
an external display step of displaying whether or not a trouble is present in the out-of-home network based on a result obtained in the external measuring step.

7. A digital television set which is one of terminals included in a home network, comprising:
an input unit as a user interface, and
a browser that transmits a transmission request input through the user interface to a router apparatus,
wherein the digital television set is connected to the home network via the router apparatus, the router apparatus including:
an HTTP server that monitors a packet among a plurality of networks, relays the packet based on information obtained from the packet, separates the home network from an out-of-home network, monitors a transmission request from an HTTP client provided in a terminal included in the home network and transmits information to the HTTP client based on the transmission request; and
a storage device that is controlled by the HTTP server and has a speed measuring page including information for measuring data transmission speed,
wherein the digital television set measures data transmission speed between the digital television set and the router apparatus based on a measuring procedure described in the speed measuring page including information for measuring data transmission speed between the digital television set and the router apparatus, which is obtained based on the transmission request from the router apparatus.

8. The digital television set of claim 7 further comprising:
a display unit that displays whether or not a trouble is present in the home network based on the data transmission speed between the digital television set and the router apparatus.

9. The digital television set of claim 7 further comprising:
a speed measuring button at lease at one of a front panel, a command acceptance screen of the browser and a remote controller of the digital television set.

10. The digital television set of claim 7,
wherein the digital television set measures data transmission speed between the digital television set and a video distribution server based on a measuring procedure described in an external speed measuring page obtained from the video distribution server via the router apparatus,
wherein the out-of-home network connected to the home network further includes the video distribution server, the video distribution server including:
an external HTTP server; and
an external storage device that is controlled by the external HTTP server and has the external speed measuring page including information for measuring data transmission speed between the digital television set and the video distribution server.

11. The digital television set of claim 10 further comprising:
a display unit that displays whether or not a trouble is present in the out-of-home network based on the data transmission speed between the digital television set and the video distribution server.

12. The digital television set of claim 10 further comprising:
an external speed measuring button at least at one of a front panel, a command acceptance screen of the browser and a remote controller of the digital television set.

13. The digital television set of claim 7 further comprising:
the router apparatus.

14. The network trouble determining method of claim 2,
wherein the terminal is a digital television set,
wherein the requesting step includes requesting the router apparatus to transmit the speed measuring page by the digital television set, and
wherein the measuring step includes measuring a bit rate between the router apparatus and the digital television set according to information in the speed measuring page transmitted from the router apparatus responding to the request.

15. The network trouble determining method of claim 14, further comprising:
a display step of displaying whether or not a trouble is present in the home network based on a result obtained in the measuring step.

16. The network trouble determining method of claim 3, further comprising:
a display step of displaying whether or not a trouble is present in the home network based on a result obtained in the measuring step.

17. The network trouble determining method of claim 5,
wherein the terminal is a digital television set,
wherein the requesting step includes requesting the video distribution server to transmit the speed measuring page by the digital television and
wherein the measuring step includes measuring a bit rate between the digital television set and the video distribution server according to information in the speed measuring page transmitted from the video distribution server to the digital television set via the router apparatus responding to the request.

18. The network trouble determining method of claim 17, further comprising:
an external display step of displaying whether or not a trouble is present in the out-of-home network based on a result obtained in the external measuring step by the digital television set.
